(19) United States
(12) Patent Application Publication
(10) Pub. No.: US 2025/0226695 A1
(43) Pub. Date: Jul. 10, 2025

(54) INDUCTIVE CHARGING DEVICE FOR A VEHICLE CHARGING SYSTEM

(71) Applicant: MAHLE International GmbH, Stuttgart (DE)

(72) Inventor: Mike Boettigheimer, Kornwestheim (DE)

(21) Appl. No.: 18/855,638

(22) PCT Filed: Mar. 24, 2023
(86) PCT No.: PCT/EP2023/057733

§ 371 Date: Oct. 9, 2024

(30) Foreign Application Priority Data
Mar. 30, 2022 (DE) 10 2022 107 568.0
Aug. 16, 2022 (DE) 10 2022 120 690.4

(51) Int. Cl. H02J 50/10; B60L 53/122; H01F 27/28; H02J 50/90

(52) U.S. Cl. CPC H02J 50/10; B60L 53/122; H01F 27/28; H02J 50/90

(57) ABSTRACT

An inductive charging device for a vehicle charging system may include an energy transmission winding, at least one flux guide element, at least one first sensor winding, and a second sensor winding. The at least one flux guide element may be configured to guide a magnetic field during an energy transmission between a further inductive charging device and the energy transmission winding. The at least one first sensor winding and the second sensor winding are arranged around the at least one flux guide element.

### CROSS-REFERENCE TO RELATED APPLICATIONS

This application claims priority to International Patent Application No. PCT/EP2023/057733, filed on Mar. 24, 2023, German Patent Application No. DE 10 2022 120 690.4, filed on Aug. 16, 2022, and German Patent Application No. DE 10 2022 107 568.0, filed on Mar. 30, 2022, the contents of all of which are hereby incorporated by reference in their entirety.

### TECHNICAL FIELD

The invention relates to an inductive charging device for a vehicle charging system according to the class of the independent patent claim.

### BACKGROUND

From DE 10 2014 202 747 A1 a double winding system is known which is used to determine a position deviation between a primary coil and a secondary coil of an inductive charging system. The two windings of the double winding system are offset from one another by a certain angle and wound around a common ferrite element. The magnetic field of the primary coil induces a voltage in the two windings. The two voltages are evaluated by an evaluation unit, and a position deviation between the primary coil and the secondary coil is calculated from this. In this case, an additional component with its own ferrite element must be installed with the double winding system. Furthermore, it is not possible to position the double winding system in such a manner that no or only very low voltages are induced during the charging process.

### SUMMARY

The present invention is concerned with the object of providing improved or at least alternative embodiments for an inductive charging device of the type mentioned above, in particular those which reduce the complexity and increase the longevity of the components used.

Being able to charge vehicles inductively offers a plurality of advantages over conventional conductive charging. First and foremost, the increase in convenience should be mentioned here, as there is no longer any need to handle charging cables and plugs, some of which are very heavy. However, for the inductive charging process it is important that the vehicle's inductive charging device is positioned as precisely as possible in relation to the stationary, for example floor-side, inductive charging device. This is difficult when performing purely manual positioning of the vehicle over the stationary inductive charging device and the driver requires support from an assistance system that either provides him with information about a position deviation between the mobile inductive charging device in the vehicle and the stationary inductive charging device or from an automated positioning system that directly takes over the parking process automatically. A sensor system is required that can detect a corresponding position deviation. It is advantageous if no initial calibration is necessary between the stationary inductive charging device and the mobile inductive charging device in the vehicle. Furthermore, it is beneficial if the positioning system has the largest possible range. This means that the positioning system should be able to precisely determine a position deviation even when the distance between a stationary inductive charging device and a mobile inductive charging device in the vehicle is as large as possible.

The device according to the invention with the features of the independent claim has the advantage over the prior art that sensor windings are integrated into the inductive charging device, no additional magnetic core or no additional flux guide element is required and, due to the arrangement of the sensor windings according to the invention, the voltages induced in the sensor windings during the charging process can be reduced to a minimum. Furthermore, the proposed arrangement also allows the sensor windings to be accommodated in the inductive charging device in the vehicle, which is usually limited by a housing. No additional wiring is necessary, as would be the case if the device were installed outside the inductive charging device in the vehicle.

Further important features and advantages of the invention are apparent from the subclaims, from the drawings and from the associated description of the figures with reference to the drawings.

It is understood that the features mentioned above and those to be explained below can be used not only in the combination specified in each case, but also in other combinations or on their own, without departing from the scope of the present invention.

An inductive charging device for a vehicle charging system is proposed here, having an energy transmission winding and at least one flux guide element and at least one first sensor winding and a second sensor winding, with the following features: the flux guide element is suitable for guiding a magnetic field during an energy transmission which takes place between a further inductive charging device and the energy transmission winding, the first sensor winding is arranged around at least one of the at least one flux guide elements, and the second sensor winding is arranged around at least one of the at least one flux guide elements.

With inductive charging, energy is transmitted in the form of a magnetic field between two inductive charging devices, usually between a stationary charging device and a mobile inductive charging device.

Thus, the term “inductive charging device” refers herein to only one of at least two parts that are necessary for an inductive charging process for energy transmission. During the induction charging process, an energy transmission winding in an inductive charging device generates an alternating magnetic field. This alternating magnetic field induces a voltage in a further energy transmission winding of a further inductive charging device. This further inductive charging device therefore serves as a counterpart for this specific charging process. The energy is transmitted wirelessly and absorbed by inducing a voltage.

Inductive charging devices can be used for inductive charging of vehicles. In principle, an inductive charging device according to the invention can be used for any type of land, water or air vehicle that has an electric or hybrid drive. In particular, passenger cars, buses and trucks are mentioned here.

A vehicle charging system comprises at least one mobile inductive charging device and a further, usually stationary, inductive charging device. A mobile inductive charging device can, for example, be mounted on and/or in a vehicle.

An inductive charging device on and/or in the vehicle is therefore suitable for absorbing the magnetic field and making electrical energy available from an energy storage device in the vehicle, for example a battery or an accumulator in the vehicle.

In principle, a vehicle charging system can also be used for bidirectional charging. The vehicle can also temporarily feed energy from the energy storage unit into the power grid via the vehicle charging system.

An inductive charging device has an energy transmission winding which can efficiently receive a magnetic field from another energy transmission winding and/or emit a magnetic field during the charging process. Preferably, powers of 3 kW to 500 KW, particularly preferably 3 kW to 50 kW, can be transmitted.

In general, a coil is defined here as a component for generating or receiving a magnetic field. A coil can consist of a winding and optionally other elements such as a magnetic core and a coil carrier. Here, a winding is a wound arrangement of a current conductor. A winding can consist of one or more turns, with one turn representing one full revolution of a conductor. In general, a winding can consist of less than one turn, for example 0.5 turns. Of course, an incomplete number of turns, such as 2.5 turns, is also possible.

An energy transmission winding can be designed in various forms and can consist, for example, of a high-frequency stranded wire with a diameter between 0.5 mm and 10 mm, preferably made of copper.

The sensor windings are required for the positioning process. If the vehicle is still some distance away, for example between 5 and 10 m, from the stationary inductive charging device, the stationary inductive charging device can emit a signal, preferably a magnetic field, which induces a voltage in the sensor windings. By comparing the voltages and evaluating them accordingly, a position deviation between the vehicle and the stationary inductive charging device can be determined. In principle, it is also possible for the mobile inductive charging device to send out the signal and the stationary inductive charging device to receive it.

A sensor winding according to the invention can be designed in different forms and can have half, one or preferably several turns. Of course, an incomplete number of turns, such as 2.5 turns, is also possible. A conductor of such a sensor winding can, for example, have a cross-sectional area between 0.01 and 2 mm². A conductor can be designed as a stranded wire, as a single conductor or in another form, for example in the form of a circuit board. In a conductor structure implemented on a circuit board, the conductor tracks can have cross-sections of, for example, the order of 0.8 μm by 35 μm.

A flux guide element is suitable for guiding a magnetic field in a predetermined manner. It has a high magnetic permeability with μᵣ>1, preferably μᵣ>50, particularly preferably μᵣ>100. The flux guide element represents a magnetic core for the energy transmission winding. In particular, the magnetic field is influenced by the high permeability in such a way that the largest possible magnetic flux is transferred to the energy transmission winding. With a flux guide element, the energy transmission winding absorbs a larger magnetic flux than without a flux guide element, all other parameters being the same. A flux guide element can be made of a ferromagnetic or preferably a ferrimagnetic material, particularly preferably a ferrite. A flux guide element can preferably be designed in a plate-like manner—in the form of a planar core—and can be arranged in the inductive charging device on the side of the energy transmission winding which faces away from the opposite side, i.e. the further inductive charging device.

By arranging the first sensor winding and the second sensor winding around at least one of the at least one flux guide elements, the at least one of the at least one flux guide elements takes on a dual function. It acts as a magnetic core for both the first sensor winding and/or the second sensor winding as well as a magnetic core or flux guide element for the energy transmission winding. This means that no separate flux guide element is required for the sensor winding, which leads to simplified manufacturing.

The arrangement of a sensor winding around a flux guide element means that at least a part of the flux guide element is enclosed by a sensor winding. The first sensor winding and the second sensor winding can be arranged around the same flux guide element or around two different flux guide elements or even around a plurality of flux guide elements each.

The two sensor windings can either be arranged only around one or a plurality of flux guide elements or also around further elements, such as the energy transmission winding and/or a cooling and/or a shielding device.

An inductive charging device according to the invention is preferably a mobile inductive charging device which is arranged on and/or in a vehicle or a stationary inductive charging device.

A stationary inductive charging device is the non-mobile part of a vehicle charging system, i.e. the part that does not move with the vehicle.

A stationary inductive charging device can preferably be located on, at or in a floor. This can be an inductive charging device mounted on the ground or an inductive charging device sunk into a substrate or floor. A floor can be a roadway, a parking lot surface, a garage floor, a floor in a parking garage or another building. Alternatively, a stationary inductive charging device can also be located on walls or similar.

It is also possible that it is a stationary inductive charging device for a dynamic inductive charging process. In a dynamic inductive charging process, an energy storage device of a vehicle can be charged while it is moving. For example, in this case the stationary inductive charging device can extend along the roadway under, in or on the road surface.

A mobile inductive charging device can be arranged on and/or in a vehicle. In general, this refers to the part of a vehicle charging system that moves with the vehicle.

It is preferred that the first sensor winding has a first radial longitudinal direction and the second sensor winding has a second radial longitudinal direction, and the first radial longitudinal direction and the second radial longitudinal direction are each arranged at an angle of 45°+/−10°, preferably at an angle of 45°, to the longitudinal direction of the vehicle, and the first radial longitudinal direction and the second radial longitudinal direction intersect at an angle of 70°-110°; preferably perpendicularly.

In general, a winding extends in at least two dimensions around an axis. The main extension direction perpendicular to the winding axis is referred to here as the radial longitudinal direction. Thus, in a winding with a rectangular, non-square cross-section, the main stretching direction runs along or parallel to the longer side of the rectangle. In a winding with an elliptical cross-section, the radial longitudinal direction runs along or parallel to the main axis of the ellipse. The radial longitudinal direction of a sensor winding according to the invention can preferably lie in a plane that extends parallel to the ground.

A corresponding arrangement of the angles of the radial longitudinal directions is advantageous for the highest possible sensitivity in detection and the simplest possible calculation of the position deviation between the vehicle and the stationary inductive charging device.

If the two angles between the respective radial longitudinal direction of the sensor windings and the longitudinal direction of the vehicle are approximately equal, this means that the sensor windings are arranged symmetrically to the direction of travel.

When the term “longitudinal direction of the vehicle” is used in relation to a stationary inductive charging device, it refers to the “longitudinal direction of the vehicle” to be achieved when the positioning process is successfully completed, i.e. the “longitudinal direction of the vehicle” as it is positioned during the energy transmission process.

This is particularly advantageous since the function of the sensor windings is in particular to detect a right-left position deviation between the inductive charging device in the vehicle and the stationary inductive charging device. Due to the symmetrical arrangement of the sensor windings in relation to the direction of travel, if the position deviations to the right or left are the same, the voltages induced in the sensor windings are also symmetrical and thus a relatively simple calculation of the position deviations from the induced voltages is possible.

If the two angles are 45°, the two sensor windings are at a 90° angle to one another, which is ideal for optimal evaluation of the sensor signals.

It is preferred that the first sensor winding has a first radial longitudinal direction and the second sensor winding has a second radial longitudinal direction and the first radial longitudinal direction and the second radial longitudinal direction intersect in the region of the area spanned by the energy transmission winding.

The region of the area spanned by the energy transmission winding refers to the area spanned by the energy transmission winding in the plane perpendicular to its winding axis. This explicitly includes the inner area of the energy transmission winding, in which there is no longer any winding, but not the area that is outside the energy transmission winding.

It is important to note that “direction”, such as “radial longitudinal direction”, always refers to a straight line and not a distance that is limited by the beginning and end of the component. The fact that the two radial longitudinal directions of the sensor windings intersect in the region of the area spanned by the energy transmission winding does not necessarily mean that the sensor windings themselves intersect; it is also possible that they would only intersect in the extension.

Arranging the two sensor windings in such a way that the two radial longitudinal directions intersect in the region of the area spanned by the energy transmission winding offers advantages for the evaluation of the two sensor signals. When a signal is sent from the stationary inductive charging device for positioning, a voltage is induced in each of the two windings, wherein the ratio of the two voltages allows direct conclusions to be drawn about the position deviation between the vehicle and the stationary inductive charging device. In particular, it is advantageous here if the two sensor windings are arranged symmetrically with respect to the longitudinal direction of the vehicle.

It is particularly preferred that the first radial longitudinal direction and the second radial longitudinal direction intersect at least approximately in the center of the energy transmission winding.

The center of the energy transmission winding refers here to the region a few centimeters around the geometric center of the energy transmission winding in the plane perpendicular to the winding axis of the energy transmission winding. “Center” here refers only to the two dimensions in which the energy transmission winding mainly extends, for example the travel plane. The intersection does not have to be centrally located in the energy transmission winding in the direction in which the energy transmission takes place, i.e. for example a central arrangement does not occur in relation to the height of the vehicle.

This is advantageous because the two radial longitudinal directions of the two sensor windings are tilted to the longitudinal direction of the vehicle by an angle that is advantageous for optimal detection of a position deviation between the vehicle and the stationary inductive charging device.

In addition, the sensor windings are arranged in relation to the energy transmission winding in such a manner that the lowest possible voltages are induced in the sensor windings during the energy transmission process.

In one embodiment, the two sensor windings intersect at least approximately in the center of the energy transmission winding. The fact that only the radial longitudinal directions of the two sensor windings intersect approximately in the center of the energy transmission winding is a weaker condition. It is also possible that the two sensor windings are relatively short and arranged in a “V” shape. If one extends these two sensor windings in their radial longitudinal direction, these radial longitudinal directions intersect with one another, but not the two sensor windings themselves. The fact that the two sensor windings intersect with one another is a stricter condition. Here, the sensor windings are longer than in a “V”-shaped arrangement and actually intersect with one another. The arrangement is “X”-shaped. In this embodiment, the sensor windings have a larger region into which voltage is induced than in embodiments in which only the radial longitudinal directions of the sensor windings intersect in the extension and more voltage can be induced. In this case, an actual intersecting of the sensor windings takes place and no longer just an intersecting in the extension of the sensor windings.

It is advantageous if, in this embodiment, the two sensor windings are arranged point-symmetrically to the center of the energy transmission winding.

In an alternative preferred embodiment, the inductive charging device has at least four sensor windings, two of which are arranged on opposite sides of the center of the energy transmission winding and all radial longitudinal directions run approximately through the center of the energy transmission winding and/or the four radial longitudinal directions of the four sensor windings each form an angle of 45°+/−10°, preferably 45°, with the longitudinal direction of the vehicle.

Thus, the four sensor windings are arranged like a cross around the center of the energy transmission winding, wherein the center of the energy transmission winding itself is free of a sensor winding.

Preferably, the four sensor windings can be arranged radially at equal distances around the center of the energy transmission winding and can be at approximately the same angle to one another. For example, the angle between the respective radial longitudinal direction of a sensor winding and the radial longitudinal direction of the respective adjacent sensor winding can always be 45°+/−10°, preferably 45°.

On the one hand, this embodiment is advantageous compared to the embodiment with only two sensor windings, since with this arrangement the installation space can be used more efficiently and thus more turns per sensor winding can be realized. Thus, more voltage is induced overall. Compared to the embodiment with two intersecting sensor windings, it also offers the advantage that the center of the energy transmission winding remains free of a sensor winding and thus stabilizing elements can be introduced in this region.

The four sensor windings can be connected to one another, preferably in series. Particularly preferably, the two diagonally opposite sensor windings are connected in series with one another.

It is advantageous that the first radial longitudinal direction and the second radial longitudinal direction are at least approximately parallel to the main direction of the magnetic field lines which form during the energy transmission in the flux guide element in the region covered by the sensor winding.

The main direction of the magnetic field lines at the respective location refers to the direction in which the magnetic field lines mainly extend in the flux guide element. The aim here is not to show the exact course of the magnetic field lines through the sensor winding, but rather the radial longitudinal directions should be oriented according to the course of the magnetic field lines in the region of the sensor winding.

During the energy transmission from the stationary inductive charging device to the inductive charging device in the vehicle, the magnetic field is guided in one or more flux guide elements. If the one or more flux guide elements are plate-shaped, a magnetic field with magnetic field lines which run approximately radially in relation to the energy transmission winding is established in the flux guide elements during the charging process. A voltage should be induced in the sensor windings during the positioning process in order to calculate a position deviation between the vehicle and the stationary inductive charging device. However, during the charging process the magnetic fields are significantly higher and it is therefore important that as little voltage as possible is induced in the sensor windings so that these or neighboring components are not destroyed. For the induced voltage, the field component perpendicular to the radial longitudinal direction of the sensor windings is relevant. If a sensor winding is arranged in such a manner that the radial longitudinal direction of the sensor winding is at least approximately parallel to the main direction of the magnetic field lines in the flux guide elements during the charging process, no or only a small voltage is induced in the sensor winding.

Alternatively, it is also possible for the first radial longitudinal direction and the second radial longitudinal direction to intersect outside the center of the energy transmission winding.

Preferably, the energy transmission winding is designed as a flat coil and/or the first sensor winding and the second sensor winding are designed as a solenoid.

A flat coil can be a spiral flat coil, in particular a circular spiral flat coil or a rectangular spiral flat coil. A spiral flat coil can be wound in the shape of an Archimedean spiral. The winding shape can be circular (circular spiral flat coil), but other shapes, such as square or rectangular or even similar to a rectangle with rounded corners, are also possible (rectangular spiral flat coil). The spiral lies in one plane. A flat coil is particularly suitable for transferring the highest possible power between a stationary inductive charging device and an inductive charging device in the vehicle.

A solenoid is also called a cylinder coil or solenoid coil. A solenoid can be wound in the form of a helix or a cylindrical spiral. However, the shape of the turns does not have to be circular, but can also have other shapes, such as square or rectangular, or even similar to a rectangle with rounded corners. The important difference to the flat coil is that the turns are not in one plane, but extend along an axis. However, two or more turns can also run parallel and thus be in the same plane perpendicular to the axis.

The shape of the solenoid is well suited to detecting a signal sent by the stationary inductive charging device during the positioning process.

In a further preferred embodiment, a plurality of flux guide elements are arranged radially around the center of the energy transmission winding, wherein gaps between the flux guide elements also run radially.

From a manufacturing point of view, it is not possible or only very difficult to produce a large flux guide element that covers the entire area of the energy transmission coil or even extends beyond it. Therefore, several smaller flux guide elements usually have to be placed next to one another. It is possible to use rectangular flux guide elements. These are easier to make. There are then always small gaps between the flux guide elements. These can negatively influence the guidance of the magnetic field. In the case of rectangular flux guide elements, the gaps between the flux guide elements will always run partially perpendicular to the magnetic field lines. It is therefore advantageous if the gaps between the flux guide elements also run radially and thus influence the guidance of the magnetic field as little as possible.

Preferably, the first sensor winding and the second sensor winding are formed by conductor tracks which are applied to at least one circuit board, preferably to at least two circuit boards, in particular to at least one upper circuit board and at least one lower circuit board.

Here, the turns of a sensor winding are realized in the form of conductor tracks on circuit boards.

The conductor tracks can be made of copper, for example.

The conductor tracks can be designed multi-layered, preferably two-layered.

The cross-section of such a conductor track can be adapted much more flexibly to the conditions dictated by the limited installation space. In particular, it is possible to design the cross-section of the conductor tracks as a rectangle with a low height, wherein the height here is in the dimension perpendicular to the substrate.

The realization of a sensor winding using conductor tracks on circuit boards makes it possible to significantly reduce the height of the sensor winding compared to conventional windings based on, for example, high-frequency stranded wires. This form of sensor winding therefore requires less installation space, particularly in the dimension along the winding axis of the energy transmission winding, which is the most critical in terms of installation space. The manufacturing process of a circuit board-based sensor winding is also simpler compared to conventional sensor windings with wound high-frequency stranded wire conductors.

It is preferred that the energy transmission winding is thermally connected to one of the at least one flux guide elements and that the at least one flux guide element is thermally connected to a cooling device, preferably to a cooling plate and/or to a metallic shield.

The fact that one component is thermally connected to another means that these two components are either directly connected to one another, i.e. they touch one another directly, or are connected to one another via solid bodies that conduct heat well. Thus, between the two components there can be one or more layers or other solid bodies such as heat-conducting intermediate layers, a thermal interface material (TIM), metal bodies or sheets, adhesives with good heat conduction, etc. In particular, the heat conduction between the two components should preferably be in the range of 0.1-1.0 K/W.

In order to dissipate waste heat from the various components of an inductive charging device, a cooling device, preferably a cooling plate, can be used. Such a cooling plate can have a fluid flowing through it and transfer absorbed waste heat to this fluid. Alternatively, a cooling plate can be solid and also release the absorbed waste heat into the ambient air, for example through cooling fins and/or a heat exchanger.

The cooling plate can be made of metal, especially aluminum.

Inductive charging creates strong magnetic and electromagnetic fields. To ensure that they do not disturb or destroy electrical components in the vehicle, or cause damage to the vehicle by heating up, they must be shielded. A metallic shield can be used for this purpose.

A metallic sheet, such as an aluminum sheet, can be used as metallic shield. However, it is also possible to make the shield slightly thicker and design it as a shielding plate.

The metallic shield can also serve as a cooling plate. For this purpose, the version with a slightly thicker shielding plate is more suitable.

It is important that the components to be cooled are thermally well connected to the cooling plate.

Here, thermally connected means that the components mentioned are in thermal contact, i.e. a thermal exchange between them is possible via a connection that conducts heat as well as possible.

The thermal path leads from the energy transmission winding via at least one flux guide element to the cooling plate. In this way, the waste heat from the energy transmission winding and the at least one flux guide element can be dissipated to the cooling plate. Since the sensor windings can be arranged in regions around the at least one flux guide element, it is important that these sensor windings disturb the thermal path as little as possible. For this reason, it is particularly important when the sensor winding is embodied on circuit boards to ensure that the area of thermally insulating circuit board material is kept as small as possible.

In general, the cooling device does not have to be designed as a cooling plate, but can be any body that is used for active or passive cooling.

In a preferred variant, at least one of the at least one circuit boards has a smaller width in a longitudinal region of the circuit board than in a contact region of the circuit board.

Here, the longitudinal region of a circuit board is the region that runs along the radial longitudinal direction of the sensor winding. The contact region of the circuit boards is located at both ends of the longitudinal region of the circuit boards. Here it is possible to contact the conductor tracks of different circuit boards with one another.

The width does not have to be reduced throughout the longitudinal region. It is also possible for the width to be only reduced in sections, or that only certain regions along the width are left out. The decisive factor in this variant is that circuit board material is saved because the circuit boards are not made entirely of circuit board material along the longitudinal region across their entire width.

This shape limits the insulating circuit board material to a minimum. Since the insulating circuit board material also has poor thermal conductivity, this optimized shape allows more waste heat to be dissipated from the various components of the inductive charging device.

Furthermore, it is possible that only one of the two contact regions is widened compared to the longitudinal region and the other contact region is designed to be the same width as the longitudinal region or even tapers towards the end.

In a preferred embodiment, the first sensor winding and the second sensor winding consist of upper conductor tracks on an upper circuit board and of lower conductor tracks on a lower circuit board.

The conductor tracks on the upper circuit board can be connected to the conductor tracks on the lower circuit board in such a way that a spiral winding is created.

The upper conductor track can be arranged predominantly above one or more flux guide elements and the lower conductor track can be arranged predominantly below one or more flux guide elements.

The terms “above” and “below” or “upper” and “lower” refer to the arrangement of an inductive charging device that extends mainly parallel to the ground. If, for example, a charging device is arranged parallel to a wall, the terms are further to be understood in the sense of “on one side of the flux guide elements” and “on the other side of the flux guide elements” without departing from the scope of the invention.

In one variant, the upper conductor tracks are soldered to the lower conductor tracks.

Preferably, the upper conductor tracks are connected to the lower conductor tracks via through-connected and/or surface-soldered plug strips and socket strips.

By using plug strips and socket strips, it is possible to establish a connection without soldering the conductor tracks during assembly of the inductive charging device. This offers significant advantages in manufacturing.

This is especially the case with the variant with the through-connected plug and socket strips.

However, the use of plug strips and socket strips can also involve a soldering process when using surface mounted or surface soldered (surface mounted device, SMD) plug strips and socket strips, which is, however, much simpler than a soldering process without the corresponding plug devices.

In an alternative preferred variant, the upper conductor tracks are connected to the lower conductor tracks via flexible circuit boards.

The upper circuit boards and the lower circuit boards can still be designed as rigid circuit boards. The flexible circuit boards ensure the connection via the vertical end faces and thus complete the winding for the coil around at least one flux guide element. This creates a combination of rigid and flexible circuit boards. This combination is also called rigid-flex circuit boards. This is also a variant that allows for simpler and more suitable production than on-site soldering.

In a further advantageous embodiment, the upper circuit boards are connected to one another. Preferably, the upper circuit boards are designed as a common upper circuit board. Since the circuit boards themselves only represent the non-conductive base for the actual conductor tracks, no connection is established between the various sensor windings, which would influence their electromagnetic properties. Because the upper circuit boards are combined as a common circuit board, a mechanically much more stable component can be produced and the assembly of only one component instead of an upper circuit board per sensor winding is also much easier. Such a common upper circuit board also makes it easier to electrically connect the sensor windings to one another, for example to connect them in series or in parallel. This means that fewer connecting conductors need to be routed to a more distant electronic device. In this variant, the region around the center of the sensor winding can be left out so that support elements can further be arranged here. In this case, the common upper circuit board is ring-shaped in the middle.

Another possibility is that the upper circuit boards are clipped to an inner circuit board ring and are thus connected to one another. Here, clipping means that a detachable connection is created between the upper circuit boards and the circuit board ring by hooking, clamping or plugging.

The first sensor winding and/or the second sensor winding can be electrically connected to an electronic device. The electronic device can advantageously be arranged on or near the shield and/or the cooling plate. The electronic device can take over the further processing and/or evaluation of the sensor signals from the sensor windings. For this purpose, the connecting lines required to connect the sensor winding to the electronic device can be routed through other components such as a shield and/or through the cooling plate. This routed part of the connecting line can be implemented analogously to the contact region of the sensor winding in the form of pin strips or in the form of flexible conductor tracks. The respective circuit board can have any shape and/or dimension. Preferably, the respective circuit board has a shape extending in the direction of the turns with a width that is formed transversely to the longitudinal direction of the turns, between 20 mm and 60 mm, in particular from 30 mm to 50 mm, preferably from 40 mm. So that several windings, especially next to one another, can be located on it. Preferably, the respective circuit board has a plurality of turns between 8 and 23, in particular from 11 to 19, preferably 15.

It may be advantageous to reduce the number of necessary feedthroughs. This can be achieved by connecting two or more of the sensor windings in series. Alternatively or additionally, several connecting lines can be bundled and routed through a feedthrough.

In an alternative advantageous embodiment, the first sensor winding and the second sensor winding are designed as a stranded wire, in particular as a high-frequency stranded wire or as a wire.

A high-frequency stranded wire consists of several wires that are insulated from one another. This offers advantages because at high frequencies the current flows mainly near the surface of a conductor and the realization with many individual conductors means that as much conductor surface as possible is available.

Here, the term wire refers to the realization as an insulated single wire, which is then also wound in the form of a plurality of turns.

One advantage of designing the sensor windings as high-frequency stranded wire or as a wire is that it is a proven and simple manufacturing method.

For this embodiment, an additional mechanical support structure can be used to prevent the high-frequency stranded wire or wire from slipping on the flux guide element.

Alternatively, it is possible to glue the high-frequency stranded wire or wire to the at least one flux guide element to prevent slipping.

A spacer structure can also be used to ensure a defined distance between the individual turns of the sensor winding.

Preferred embodiments of the invention are illustrated in the drawings and are explained in more detail in the following description, wherein identical reference numerals refer to identical or similar or functionally identical components.

### BRIEF DESCRIPTION OF THE DRAWINGS

In the figures, schematically in each case:

FIG. 1 shows a highly simplified representation of a vehicle with an inductive charging device,

FIG. 2 shows a sectional view of an inductive charging device for a vehicle charging system,

FIG. 3 shows a plan view of an inductive charging device according to the invention,

FIG. 4 shows a plan view of an inductive charging device according to the invention in another embodiment,

FIG. 5 shows a plan view of an inductive charging device according to the invention in a further embodiment,

FIG. 6 shows a perspective view of a sensor winding arranged around a flux guide element,

FIG. 7 shows a perspective view of an alternative sensor winding arranged around a flux guide element,

FIG. 8 shows a sectional view of the sensor winding of FIG. 7 along the section line VIII,

FIG. 9 shows a sectional view through part of an inductive charging device according to the invention with a corresponding thermal path,

FIG. 10 shows a top view of two versions of circuit boards for sensor windings,

FIG. 11 shows a plan view of an inductive charging device according to the invention in an alternative embodiment,

FIG. 12 shows a perspective view of an alternative sensor winding with pin and socket strips arranged around a flux guide element,

FIG. 13 shows a plan view of upper circuit boards for sensor windings for an inductive charging device according to the invention in a further embodiment.

FIG. 14 shows a sectional view through part of an inductive charging device according to the invention with a feedthrough of cables through a shield and/or cooling plate

FIG. 15 shows a sectional view through part of another embodiment of an inductive charging device according to the invention.

### DETAILED DESCRIPTION

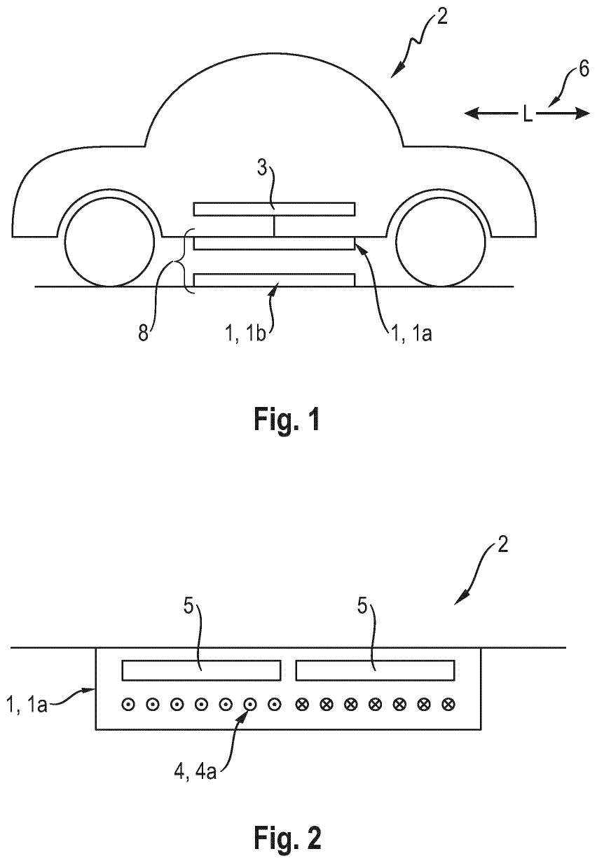

If a part in the figures is designated by reference numerals separated by commas, this means that both descriptions apply to the concrete designated part. For example, in FIG. 1, 1,1a means: This is an inductive charging device and it is also a mobile inductive charging device.

FIG. 1 shows a mobile inductive charging device 1a, which is arranged on a vehicle 2 having an energy storage device 3 and is positioned above a stationary inductive charging device 1b. During operation, energy can be transferred from the stationary inductive charging device 1b to the mobile inductive charging device 1a and the energy storage device of the vehicle 3 can be charged thereby.

The mobile inductive charging device 1a and the stationary inductive charging device 1b together form or are part of a vehicle charging system 8. In principle, it is also possible to operate the vehicle charging system 8 bidirectionally. In this case, energy can be temporarily transferred from the mobile inductive charging device 1a to the stationary inductive charging device 1b. The stationary inductive charging device 1b arranged on the ground in FIG. 1 can alternatively be arranged sunk into the roadway (not shown here). In a sunk arrangement, the inductive charging device 1b can be covered by certain layers of the road surface or can be flush with the road surface.

FIG. 2 shows a lateral section through an inductive charging device 1,1a which includes a plurality of flux guide elements 5 and an energy transmission winding 4,4a and is mounted on a vehicle 2.

A corresponding arrangement exists for a stationary inductive charging device 1b, except that it is arranged on a surface instead of on a vehicle 2 (not shown).

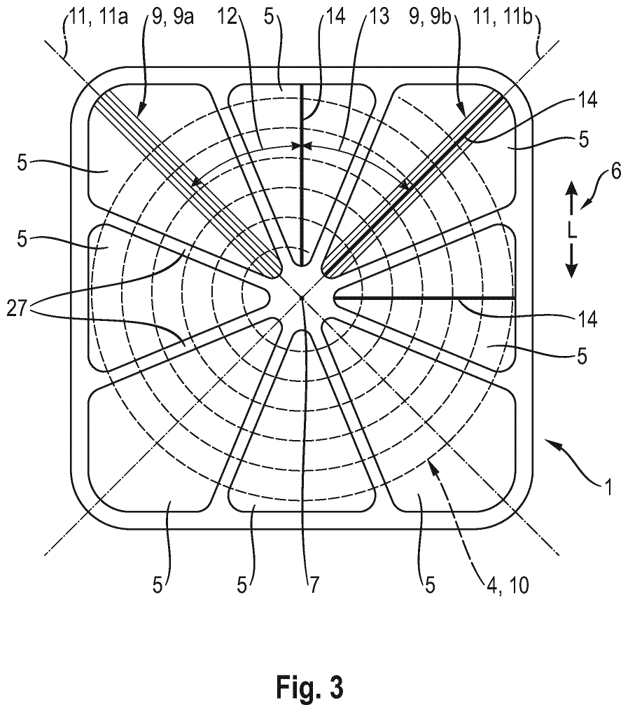

FIG. 3 shows a plan view of an inductive charging device 1 according to the invention. This can be a mobile inductive charging device 1a or a stationary inductive charging device 1b. In the present embodiment, eight flux guide elements 5 are shown, which are arranged radially around the center 7 of the energy transmission winding 4 in the plane. Between the flux guide elements 5 there are narrow gaps 27. The gaps also run radially around the center 7, thus the gaps run approximately in the main direction of the magnetic field lines (here symbolically indicated by three magnetic field lines 14), which arises during an energy transmission in the flux guide elements 5. The energy transmission winding 4, which is hidden by the flux guide elements 5 in the plan view, is indicated by dashed lines. The energy transmission winding 4 here is a flat coil 10. A first sensor winding 9,9a is arranged around one of the flux guide elements 5 and a second sensor winding 9,9b is arranged around another flux guide element 5. The sensor windings are designed as solenoids, also called cylinder coils. The first sensor winding 9a is arranged axially symmetrically to the second sensor winding 9b with respect to the longitudinal direction of the vehicle 6. The first sensor winding 9a has a first radial longitudinal direction 11a and the second sensor winding 9b has a second radial longitudinal direction 11b. The angle 12 between the first radial longitudinal direction 11a and the longitudinal direction 6 of the vehicle 2 is at least approximately the same as the angle 13 between the second radial longitudinal direction 11b and the longitudinal direction of the vehicle. The first radial longitudinal direction 11a and the second radial longitudinal direction 11b intersect or cross at least approximately in the center 7 of the energy transmission winding 4. The first radial longitudinal direction 11a and the second radial longitudinal direction 11b extend radially outwards from the center 7 of the energy transmission winding 4.

During the charging process, the vehicle 2 is positioned above the stationary inductive charging device 1b and energy is transferred to the inductive charging device 1a. The flux guide elements 5 assume the function of flux guide. In them, the field lines of the magnetic field run approximately in a radial direction in the charging state. In FIG. 3, three magnetic field lines 14 are symbolically indicated. Since the first radial longitudinal direction 11a and the second radial longitudinal direction 11b are also aligned radially and thus at least approximately parallel to the magnetic field lines 14, only relatively little or no voltage is induced in the first sensor winding 9a and in the second sensor winding 9b. This is important because the high power of the energy transmission and thus high flux densities could otherwise easily lead to the destruction of the sensor windings. Additional effort to prevent the destruction of the arrangement is therefore not necessary.

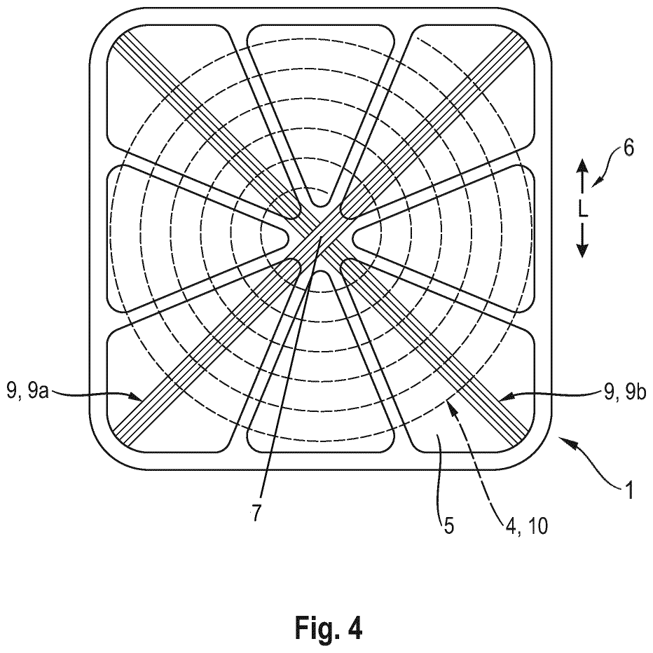

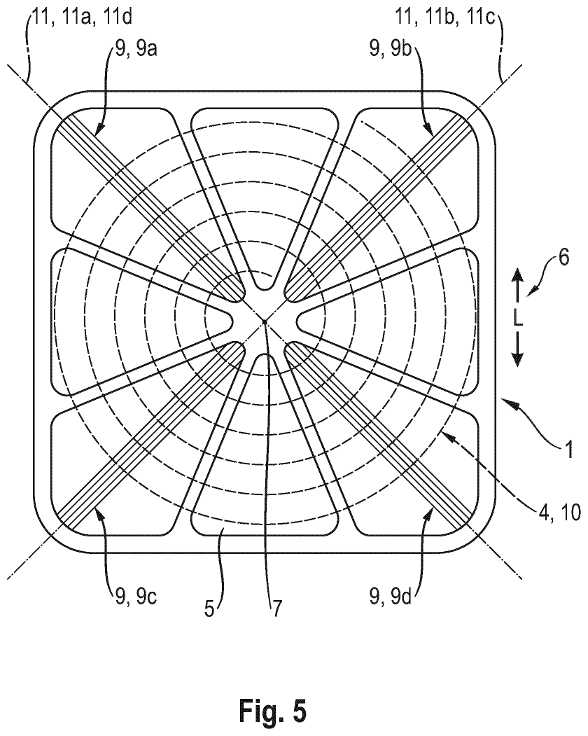

In FIG. 4 and FIG. 5, for reasons of clarity, not all elements or components already shown are again designated with reference numerals. The elements or components in these figures which are no longer designated with a separate reference numeral are to be understood as labeled in the previous figures. FIG. 4 shows a plan view of another embodiment of an inductive charging device 1 according to the invention. In contrast to the embodiment of FIG. 3, here the first sensor winding 9a runs around two flux guide elements 5 which are diagonally opposite one another with respect to the center 7 of the energy transmission coil 4. The second sensor winding 9b is wound accordingly around two further flux guide elements 5, which are also diagonally opposite one another with respect to the center 7. Here, the first sensor winding 9a and the second sensor winding 9b intersect approximately in the center 7 of the energy transmission coil 4.

FIG. 5 shows a plan view of another embodiment of an inductive charging device 1 according to the invention. Here, there are four sensor windings 9a, 9b, 9c and 9d with four radial longitudinal directions 11a, 11b,11c, 11d. Each sensor winding is arranged around a different flux guide element 5. Two of the flux guide elements are located diagonally opposite one another with respect to the center 7 of the energy transmission coil 4. Together, the four sensor windings 9a, 9b, 9c and 9d again form a cross-shaped arrangement. An advantage over the arrangement of FIG. 4 is that the area around the center 7 of the energy transmission coil 4 is designed without a sensor winding 9. This means that mechanically necessary support elements (not shown) can further be arranged here.

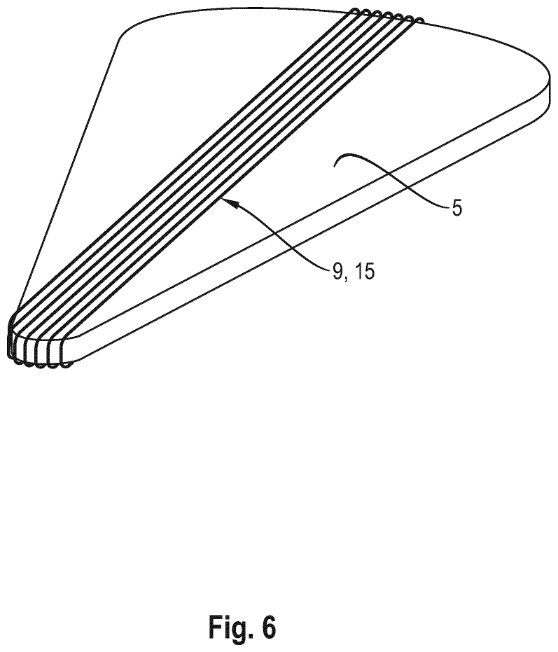

FIG. 6 now shows a flux guide element 5. A sensor winding 9 is arranged around this flux guide element. It is designed as a copper stranded wire 15.

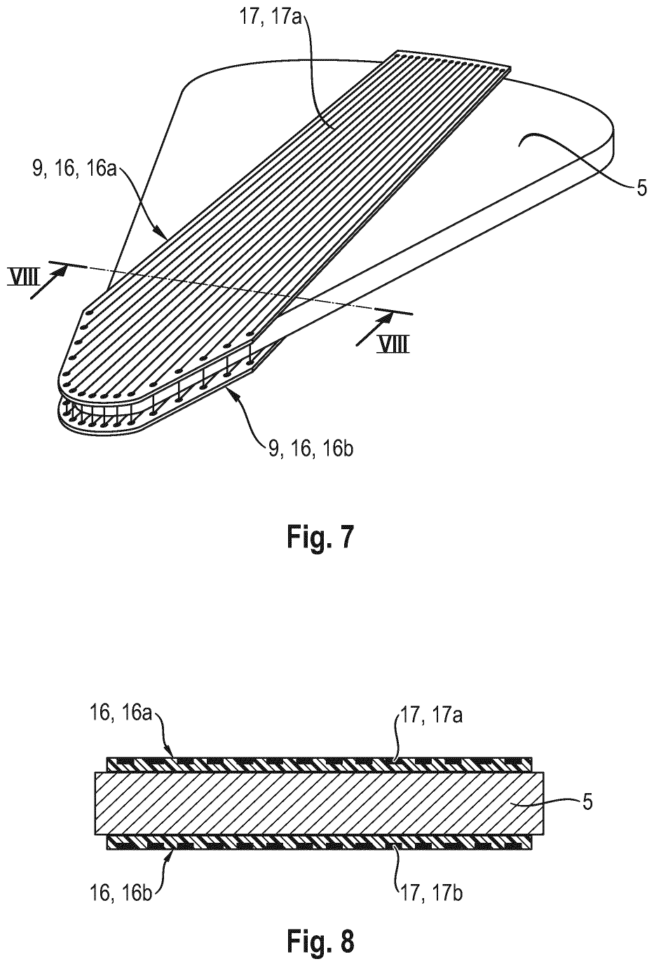

FIG. 7 shows in a perspective view and FIG. 8 in a sectional view along the section line VIII of FIG. 7 an alternative embodiment of a flux guide element 5 with a sensor winding 9. Here, the sensor winding 9 is designed in the form of a circuit board 16 with conductor tracks 17. The upper conductor tracks 17a on the upper circuit board 16a are connected to the lower conductor tracks 17b on the lower circuit board 16b in such a way that they form a continuous winding.

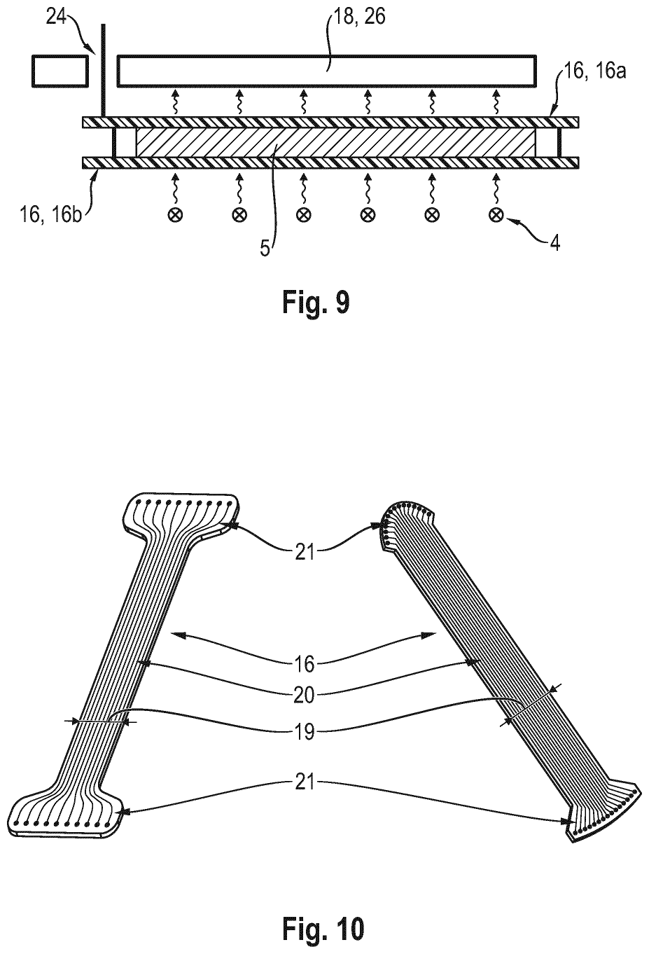

FIG. 9 shows the thermal connection of the various components to a cooling plate 18 and/or a metallic shield 26. This cooling plate 18 or this metallic shield 26 has not been shown in all previous embodiments for reasons of clarity, but can be present in all previous and subsequent embodiments. The cooling plate 18 can be solid, realized as a thin sheet, or have fluid flowing through it. The cooling plate 18 can additionally assume the function of the metallic shield 26 or be designed as a separate component. Also, only a cooling plate 18 or only a metallic shield 26 may be present. The energy transmission winding 4 transfers its heat to the flux guide element 5 via the lower circuit board 16b. Here, the heat, together with the heat generated there, is conducted via the upper circuit board 16a to the cooling plate 18 or to the metallic shield 26. Since the circuit boards 16 do not have very good thermal conductivity, it is important that the circuit board material is only used where it is necessary.

Therefore, FIG. 10 shows two different possibilities of an optimized shape of a circuit board 16. The width of the circuit board 19 is significantly smaller in the longitudinal region 20 of the circuit board than in the contact region of the circuit board 21. The longitudinal region 20 of the circuit board is the region that runs along the top or bottom of the flux guide elements 5. In the right-hand embodiment, one of the two contact regions 21 is additionally designed with a semicircular, tapered end.

The previous embodiments always showed flux guide elements 5 which had no interruptions along the magnetic field lines which arise in the radial direction during the charging process. The gaps between the flux guide elements as shown in FIG. 3 to FIG. 7 also always run radially. This is preferred with regard to the guidance of the magnetic field.

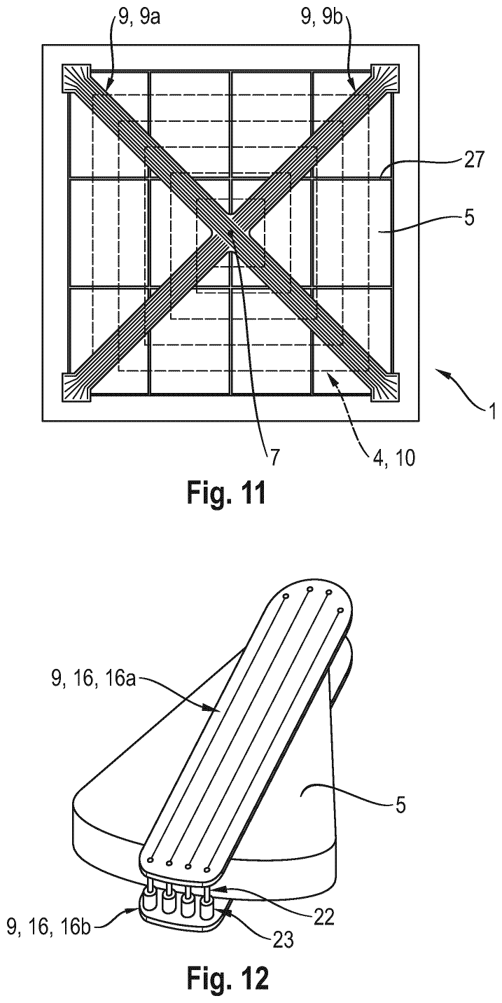

For manufacturing reasons, however, rectangular flux guide elements 5, as shown in FIG. 11, are also conceivable. Here, however, the gaps 27 do not run parallel to the direction of the magnetic field lines arising in the flux guide elements 5. Here too, it is possible to arrange the sensor windings 9a and 9b around the flux guide elements 5, wherein here too the sensor windings 9a and 9b intersect at least approximately in the center 7 of the energy transmission winding. In this embodiment, the same circuit board is used for both sensor windings 9a and 9b. The conductor tracks of the respective sensor windings 9a and 9b are located in different “layers” of the circuit board and therefore also intersect here without creating a short circuit. In FIG. 11, the energy transmission winding 4 also has a rectangular shape.

FIG. 12 shows a further alternative embodiment of the arrangement of a sensor winding 9 around a flux guide element 5. Here too, the sensor winding 9 is formed from conductor tracks 17 on circuit boards 16. Here, the connection between the upper conductor tracks 17a on the upper circuit board 16a and the lower conductor tracks 17b on the lower circuit board 16b is made by pin strips 22 and socket strips 23.

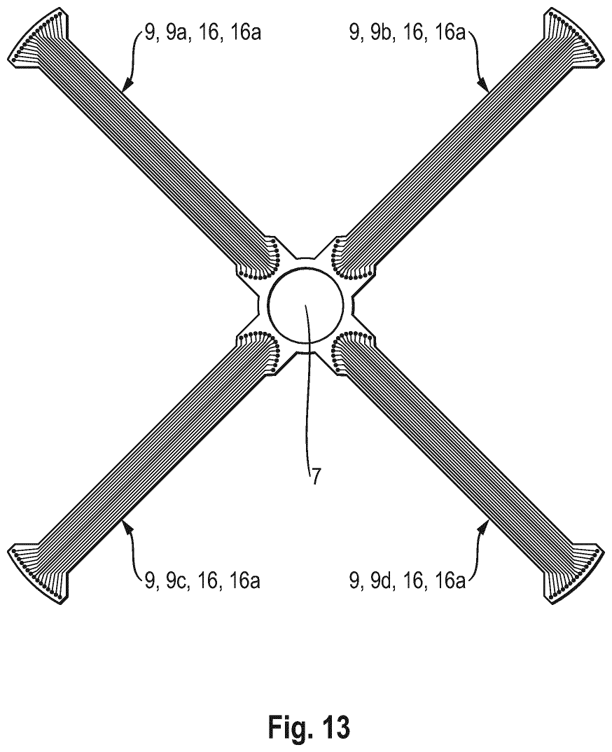

FIG. 13 shows another embodiment. Here, only the upper circuit boards 16a for the sensor windings 9a, 9b, 9c and 9d for an inductive charging device 1 are shown. Four upper circuit boards 16a for four sensor windings 9a, 9b, 9c and 9d are shown here. However, here the upper circuit boards 16a are connected to one another in a ring shape in the region of the center 7 of the energy transmission winding 4. This has manufacturing advantages. In this embodiment, it is also additionally possible to attach mechanical supports in the middle of the sensor winding.

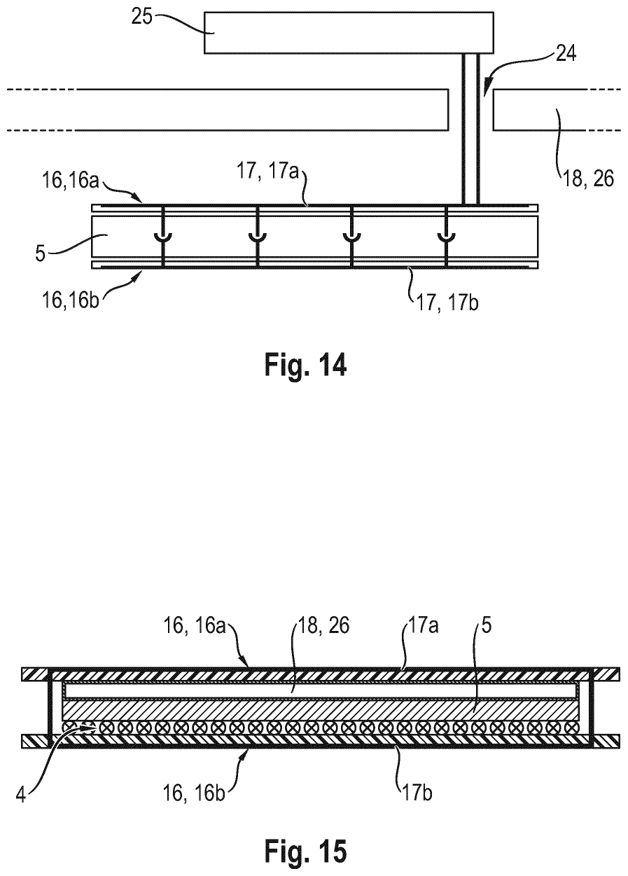

FIG. 14 shows a sectional view through a part of an inductive charging device according to the invention with a feedthrough of lines 24 through a shield 26 and/or through a cooling plate 18 to an electronic device 25. The shield 26 and the cooling plate 18 may also be the same component.

The upper conductor tracks 17a are arranged with the lower conductor tracks 17b around a flux guide element 5 and connected to one another in such a way that they form a sensor winding 9. This sensor winding 9 is connected to an electronic device 25 via two electrical lines per sensor winding for evaluation. These lines are connected to the upper conductor tracks 17a on the upper circuit board 16a. A metallic shield 26 and/or a cooling plate 18 is arranged above the sensor winding 9. The electronic device 25 is located on or above the metallic shield 26 and/or the cooling plate 18. Therefore, it is necessary to pass the cables 24 through the metallic shield 26 and/or a cooling plate 18. For this purpose, in the present example, a recess is made in the metallic shield 26 and/or the cooling plate 18 and the lines can be guided through the recess through the metallic shield 26 and/or the cooling plate 18 and connected to the electronic device 25 above the metallic shield 26 and/or the cooling plate 18.

It is not necessary to realize a separate feedthrough of the cables 24 through the shield 26 and/or the cooling plate 18 for each sensor winding 9. It is also possible for a plurality of sensor windings 9 to be connected to one another—in series or in parallel or in a combination—and then only one feedthrough of the lines 24 can be realized for these several sensor windings 9.

FIG. 15 shows a sectional view through an alternative inductive charging device according to the invention. Here, too, a sensor winding 9 is realized from conductor tracks 17 on circuit boards 16 and arranged around a flux guide element 5. For this purpose, the upper conductor tracks 17a on an upper circuit board 16a are electrically connected to the lower conductor tracks 17b on a lower circuit board 16b. Here, the upper circuit board 16a is not arranged directly above the flux guide element 5 and the lower circuit board 16b is not arranged directly below the flux guide element 5. The sensor winding 9 in the form of the two circuit boards 16 also encloses the shield 26 and/or the cooling plate 18 as well as the energy transmission winding 4. The upper circuit board 16a is arranged here above the shield 26 and/or the cooling plate 18. Here, the lower circuit board 16b is arranged below the energy transmission winding 4.

1. An inductive charging device for a vehicle charging system, comprising:
an energy transmission winding;
at least one flux guide element;
at least one first sensor winding; and
a second sensor winding;
wherein the at least one flux guide element is configured to guide a magnetic field during an energy transmission between a further inductive charging device and the energy transmission winding; and
wherein the at least one first sensor winding and the second sensor winding are arranged around the at least one flux guide element.

2. The inductive charging device according to claim 1, wherein the inductive charging device is one of:
a mobile inductive charging device arranged at least one of on and in a vehicle; and
a stationary inductive charging device.

3. The inductive charging device according to claim 1, wherein:
the at least one first sensor winding has a first radial longitudinal direction;
the second sensor winding has a second radial longitudinal direction;
the first radial longitudinal direction is arranged at a first angle of 35° to 55° to a longitudinal direction of a vehicle;
the second radial longitudinal direction is arranged at a second angle of 35° to 55° to the longitudinal direction of the vehicle; and
the first radial longitudinal direction and the second radial longitudinal direction intersect at a third angle of 70° to 110°.

4. The inductive charging device according to claim 1, wherein:
the at least one first sensor winding has a first radial longitudinal direction;
the second sensor winding has a second radial longitudinal direction;
the first radial longitudinal direction and the second radial longitudinal direction intersect in a region of an area spanned by the energy transmission winding.

5. The inductive charging device according to claim 3, wherein the first radial longitudinal direction and the second radial longitudinal direction intersect at least approximately in a center of the energy transmission winding.

6. The inductive charging device according to claim 1, further comprising at least four sensor windings, wherein:
two windings of the at least four sensor windings are arranged on opposite sides of a center of the energy transmission winding; and
the at least four sensor windings each have a respective radial longitudinal direction that at least one of:
extends approximately through a center of the energy transmission winding; and
forms an angle of 35° to 55° with a longitudinal direction of a vehicle.

7. The inductive charging device according to claim 3, wherein the first radial longitudinal direction and the second radial longitudinal direction are at least approximately parallel to a main direction of a plurality of magnetic field lines which form present during the energy transmission in the at least one flux guide element in a region covered by the at least one first sensor winding and the second sensor winding.

8. The inductive charging device according to claim 3, wherein the first radial longitudinal direction and the second radial longitudinal direction intersect outside of a center of the energy transmission winding.

9. The inductive charging device according to claim 1, wherein at least one of:
the energy transmission winding is a flat coil; and
the at least one first sensor winding and the second sensor winding are each a solenoid.

10. The inductive charging device according to claim 1, wherein:
the at least one flux guide element includes a plurality of flux guide elements arranged radially around a center of the energy transmission winding; and
a plurality of gaps disposed between the plurality of flux guide elements extend radially.

11. The inductive charging device according to claim 1, wherein the at least one first sensor winding and the second sensor winding are structured as a plurality of conductor tracks applied to at least one circuit board.

12. The inductive charging device according to claim 1, wherein:
the energy transmission winding is thermally connected to the at least one flux guide element; and
the at least one flux guide element is thermally connected to a cooling device.

13. The inductive charging device according to claim 11, wherein the at least one circuit boards has a smaller width in a longitudinal region of the at least one circuit board than in a contact region of the at least one circuit board.

14. The inductive charging device according to claim 11, wherein the at least one first sensor winding and the second sensor winding include:
a plurality of upper conductor tracks arranged on at least one upper circuit board; and
a plurality of lower conductor tracks arranged on at least one lower circuit board.

15. The inductive charging device according to claim 14, wherein the plurality of upper conductor tracks are soldered to the plurality of lower conductor tracks.

16. The inductive charging device according to claim 15, wherein the plurality of upper conductor tracks are connected to the plurality of lower conductor tracks via at least one of i) a plurality of through-connected plug strips and socket strips and ii) a plurality of surface-soldered plug strips and socket strips.

17. The inductive charging device according to claim 14, wherein the plurality of upper conductor tracks are connected to the plurality of lower conductor tracks via a plurality of flexible circuit boards.

18. The inductive charging device according to claim 14, wherein:
the at least one upper circuit board includes a plurality of upper circuit boards; and
the plurality of upper circuit boards are connected to one another.

19. The inductive charging device according to claim 1, wherein the at least one first sensor winding and the second sensor winding are each structured as a stranded wire.

20. The inductive charging device according to claim 3, wherein:
the first angle is 45°;
the second angle is 45°; and
the third angle is 90°.
